(19) United States
(12) Patent Application Publication
(10) Pub. No.: US 2024/0313350 A1
(43) Pub. Date: Sep. 19, 2024

(54) SOLID-LIQUID HYBRID ELECTROLYTE MEMBRANE FOR LITHIUM SECONDARY BATTERY

(71) Applicant: LG ENERGY SOLUTION, LTD., Seoul (KR)

(72) Inventors: Jung Pil LEE, Daejeon (KR); Hyeaeun HAN, Daejeon (KR); Jihoon RYU, Daejeon (KR); Dong Kyu KIM, Daejeon (KR)

(21) Appl. No.: 18/577,195

(22) PCT Filed: Nov. 9, 2022
(86) PCT No.: PCT/KR2022/017564

§ 371 Date: Jan. 5, 2024

(30) Foreign Application Priority Data
Nov. 12, 2021 (KR) 10-2021-0155865

(51) Int. Cl. H01M 50/446; H01M 10/0525; H01M 10/0565; H01M 10/0566

(52) U.S. Cl. CPC H01M 50/446; H01M 10/0525; H01M 10/0565; H01M 10/0566; H01M 2300/0082; H01M 2300/0091

(57) ABSTRACT

A solid phase-liquid phase hybrid electrolyte membrane and a lithium secondary battery comprising the same are provided. The solid phase-liquid phase hybrid electrolyte membrane comprises a polymer; liquid phase polyhedral oligomeric silsesquioxane (POSS) represented by Formula 1; and a lithium salt. The solid phase-liquid phase hybrid electrolyte membrane does not leak or volatilize at normal pressure or pressure applied conditions, has high ion conductivity and excellent stability and mechanical strength, and provides excellent charging/discharging characteristics and lifetime characteristics of the lithium secondary battery.

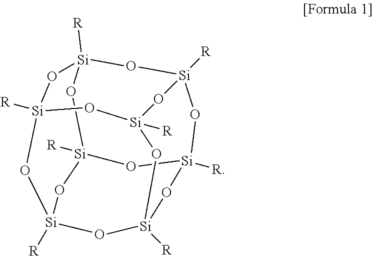

### CROSS-REFERENCE TO RELATED APPLICATION (S)

This application is a National Stage Application of International Application No. PCT/KR2022/017564 filed on Nov. 9, 2022, which claims the benefit of priority based on Korean Patent Application No. 10-2021-0155865 filed on Nov. 12, 2021, the disclosures of which are incorporated herein by reference in their entirety.

### TECHNICAL FIELD

The present disclosure relates to a solid phase-liquid phase hybrid electrolyte membrane for a lithium secondary battery.

### BACKGROUND ART

The importance of lithium secondary batteries is increasing with the increase in the use of vehicles, computers, and portable terminals. Among them, the development of a lithium secondary battery capable of generating high energy density with a light weight is particularly required. Such a lithium secondary battery consists of a liquid or solid electrolyte along with the separator interposed between the positive electrode and negative electrode.

Since the lithium-ion secondary battery using the liquid electrolyte has a structure in which the negative electrode and the positive electrode are separated by the separator, if the separator is damaged by deformation or external impact, a short circuit may occur, and thus there is a problem that leakage and volatilization occur, or risk of overheating or explosion occurs. Therefore, there is a need to improve the safety of the lithium-ion secondary battery to which the existing liquid electrolyte is applied.

In addition, an all-solid-state battery using the solid electrolyte has increased stability of the battery and can prevent leakage of the electrolyte solution, thereby improving the reliability of the battery. However, in the case of the solid electrolyte, the ion conductivity at room temperature is very low, and thus there is a problem that the performance of the battery is deteriorated. Therefore, even if a solid electrolyte is used, it is still necessary to develop a solid electrolyte membrane with high energy density and improved processability.

Therefore, it is necessary to secure technology for a lithium-ion secondary battery to which a solid phase-liquid phase hybrid electrolyte or a solid electrolyte are applied, without leakage of the electrolyte solution, instead of the existing liquid electrolyte for the transfer of ions.

Related Art

Korean Laid-open Patent Publication No. 2003-0097009 (2003.12.31), “Polymer electrolyte with good leakage-resistance and lithium battery employing the same”

### SUMMARY OF THE INVENTION

In order to solve the above-mentioned technical problems, one aspect of the present disclosure is to provide a solid phase-liquid phase hybrid electrolyte membrane for a lithium secondary battery that does not leak or volatilize in an environment of normal pressure or high pressure, has excellent mechanical strength, and has high ion conductivity, and to provide a lithium secondary battery with improved performance by comprising the same.

Other objects and advantages of the present disclosure will be understood from the following description. Further, it will be readily apparent that the objects and advantages of the present disclosure may be realized by means or methods set forth in the claims and combinations thereof.

One aspect of the present disclosure provides a solid phase-liquid phase hybrid electrolyte membrane comprising a polymer; a liquid phase polyhedral oligomeric silsesquioxane (POSS) represented by the following Formula 1; and a lithium salt:

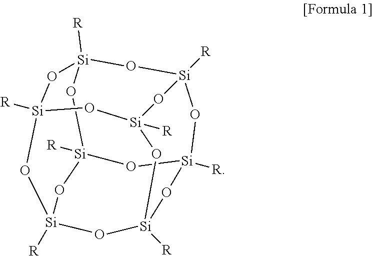

wherein,

each R is the same as or different from each other, and is independently selected from the group consisting of groups represented by Formulas 1-1 to 1-4,

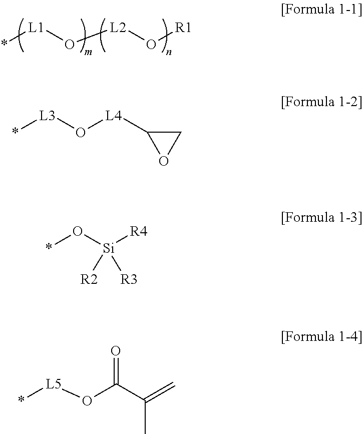

wherein,

L1 to L5 are a C1 to C30 alkylene group,

R1 to R4 are selected from the group consisting of hydrogen; a hydroxyl group; an amino group; a thiol group; a C1 to C30 alkyl group; a C2 to C30 alkenyl group; a C2 to C30 alkynyl group; a C1 to C30 alkoxy group; and a C1 to C30 carboxyl group,

m and n are the same as or different from each other, and are each independently an integer of 0 to 10, and

* is a binding position.

In one embodiment of the present disclosure, in Formulas 1-1 to 1-4, L1 to L5 are a C1 to C10 alkylene group, R1 to R4 are hydrogen; hydroxyl group; or a C1 to C30 alkyl group, m and n are the same as or different from each other, and are each independently an integer of 0 to 10.

In one embodiment of the present disclosure, in Formula 1, R is selected from the group consisting of a polyethylene glycol group, a glycidyl group, a dimethylsilyloxy group and a methacrylic group.

In one embodiment of the present disclosure, the polymer comprises a polypropylene carbonate (PPC), a polyvinylidene fluoride a (PVDF), polyacrylonitrile (PAN), or a polyvinylpyrrolidone (PVP), as a main chain or a side chain.

In one embodiment of the present disclosure, the lithium salt comprises one or more selected from the group consisting of LiPF₆, LiBF₄, LiSbF₆, LiAsF₆, LiOH, LiOH·H₂O, LiBOB, LiClO₄, LiN(C₂FsSO₂)₂, LiN(CF₃SO₂)₂, CF₃SO₃Li, LiC(CF₃SO₂)₃, LiC₄BO₈, LiFSI, LiClO₄ and combinations thereof.

In one embodiment of the present disclosure, a content ratio of the polymer and the liquid phase polyhedral oligomeric silsesquioxane is from 1:1 to 1:8.

In one embodiment of the present disclosure, a content ratio of the liquid phase polyhedral oligomeric silsesquioxane and the lithium salt is from 10:1 to 1:5.

In one embodiment of the present disclosure, an ion conductivity of the solid phase-liquid phase hybrid electrolyte membrane is 1.0×10⁻⁷ to 9.0×10⁻⁵ S/cm at 25° C.

In one embodiment of the present disclosure, the thickness of the solid phase-liquid phase hybrid electrolyte membrane is 1 to 200 μm.

Another aspect of the present disclosure provides a lithium secondary battery comprising a positive electrode; a negative electrode; and the solid phase-liquid phase hybrid electrolyte membrane according to the present disclosure.

The solid phase-liquid phase hybrid electrolyte membrane for the lithium secondary battery according to one aspect of the present disclosure does not leak or volatilize even under normal pressure and pressure applied conditions, has high ion conductivity, and has excellent stability and mechanical strength.

In addition, the lithium secondary battery including the solid phase-liquid phase hybrid electrolyte membrane for the lithium secondary battery has excellent charging/discharging characteristics and lifetime characteristics.

### DESCRIPTION OF DRAWINGS

FIG. 1 schematically shows the solid phase-liquid phase hybrid electrolyte membrane according to one aspect of the present disclosure.

### DETAILED DESCRIPTION

Hereinafter, the present disclosure will be described in detail with reference to the accompanying drawings so that those skilled in the art can easily carry out the present disclosure. However, the present disclosure may be embodied in many different forms and is not limited thereto.

The terms and words used in the present specification and claims should not be construed as limited to ordinary or dictionary terms, and should be construed in a sense and concept consistent with the technical idea of the present disclosure, based on the principle that the inventor can properly define the concept of a term to describe his invention in the best way possible.

The terminology used herein is for the purpose of describing a particular embodiment only and is not intended to be limiting of the invention. The singular expressions comprise plural expressions unless the context clearly dictates otherwise. It is to be understood that the terms such as “comprise” or “have” as used in the present specification, are intended to designate the presence of stated features, numbers, steps, operations, components, parts or combinations thereof, but not to preclude the possibility of the presence or addition of one or more other features, numbers, steps, operations, components, parts, or combinations thereof.

The present disclosure relates to a solid phase-liquid phase hybrid electrolyte membrane, a manufacturing method thereof, and a lithium secondary battery comprising the same.

The solid phase-liquid phase hybrid electrolyte membrane according to one aspect of the present disclosure comprises a solid phase polymer and a liquid phase polyhedral oligomeric silsesquioxane (POSS). The solid phase-liquid phase hybrid electrolyte membrane contains a liquid phase and is in the form of a solid phase, and leakage and volatilization do not occur under normal pressure and pressure applied conditions. This solid phase-liquid phase hybrid electrolyte membrane contains a predetermined amount of liquid phase polyhedral oligomeric silsesquioxane in the solid phase polymer chain structure, wherein the liquid phase polyhedral oligomeric silsesquioxane may be impregnated into the solid phase polymer chain structure, or the liquid phase polyhedral oligomeric silsesquioxane may be coated on a portion where the solid phase polymers are in contact with each other, or on their surfaces. The solid phase-liquid phase hybrid electrolyte membrane according to the present disclosure comprises a solid phase polymer having low ion conductivity, but it also comprises an appropriate amount of a liquid phase polyhedral oligomeric silsesquioxane, thereby securing improved ion conductivity compared to conventional solid electrolyte membranes and at the same time having free-standing mechanical strength.

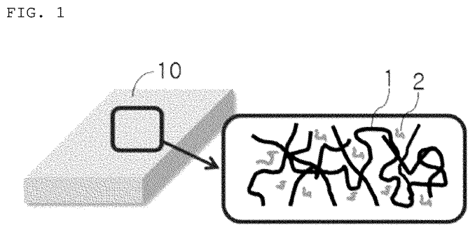

FIG. 1 schematically shows the structure of the solid phase-liquid phase hybrid electrolyte membrane according to one aspect of the present disclosure. Hereinafter, the present disclosure will be described in more detail with reference to the drawings.

Referring to FIG. 1, the solid phase-liquid phase hybrid electrolyte membrane 10 according to one aspect of the present disclosure comprises a solid phase polymer 1 and a predetermined amount of a liquid phase polyhedral oligomeric silsesquioxane 2.

The solid phase polymer 1 is a solid at room temperature. Also, it is a polymeric material with low solubility in the electrolyte solution.

The liquid phase polyhedral oligomeric silsesquioxane 2 is a liquid at room temperature. When thermal curing is performed on the liquid phase polyhedral oligomeric silsesquioxane, its polymerization occurs and it can be converted into a solid. According to the present disclosure, the solid phase-liquid phase hybrid electrolyte membrane can be prepared by mixing a solid phase polymer and a liquid phase polyhedral oligomeric silsesquioxane in a specific ratio. A more specific description is as described below.

The solid phase-liquid phase hybrid electrolyte membrane according to one aspect of the present disclosure may include a polymer; a liquid phase polyhedral oligomeric silsesquioxane (POSS) represented by the following Formula 1; and a lithium salt:

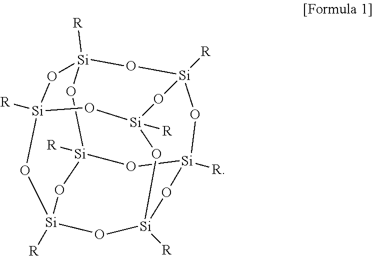

wherein,

each R is the same as or different from each other, and is independently selected from the group consisting of groups represented by Formulas 1-1 to 1-4:

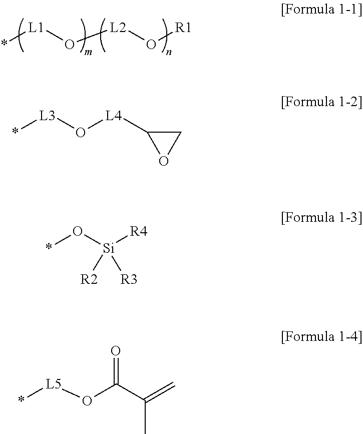

wherein,

L1 to L5 are a C1 to C30 alkylene group,

R1 to R4 are selected from the group consisting of hydrogen; a hydroxyl group; an amino group; a thiol group; a C1 to C30 alkyl group; a C2 to C30 alkenyl group; a C2 to C30 alkynyl group; a C to C30 alkoxy group; and a C1 to C30 carboxyl group,

m and n are the same as or different from each other, and are each independently an integer of 0 to 10,

* is a binding position.

The polyhedral oligomeric silsesquioxane (POSS) has various structures such as random structures, ladder structures, cage structures, and partial cage structures. Among them, the polyhedral oligomeric silsesquioxane comprised in the solid phase-liquid phase hybrid electrolyte membrane according to the present disclosure has a silica cage structure with a diameter of about 1 to 5 nm depending on the size of the cage, and is an organic-inorganic complex with properties of both silica (SiO₂) which is an inorganic substance, and silicone (R₂SiO) which is an organic substance. The polyhedral oligomeric silsesquioxane can increase mechanical properties and mechanical strength by reducing the empty space of the electrolyte to form a more robust and dense structure.

The inventors of the present disclosure found that the ion conductivity could be improved by mixing a solid phase polymer having low ion conductivity with a liquid phase polyhedral oligomeric silsesquioxane represented by the following Formula 1. By mixing the solid phase polymer and the liquid phase polyhedral oligomeric silsesquioxane of the present disclosure, since the polyhedral oligomeric silsesquioxane is positioned between the polymer chains, the movement of the polymer chains is facilitated, and thus lithium ions are also easily moved, the ion conductivity is improved. The liquid phase polyhedral oligomeric silsesquioxane represented by Formula 1 is as follows:

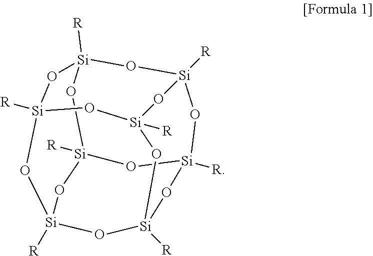

wherein,

each R is the same as or different from each other, and is independently selected from the group consisting of groups represented by Formulas 1-1 to 1-4:

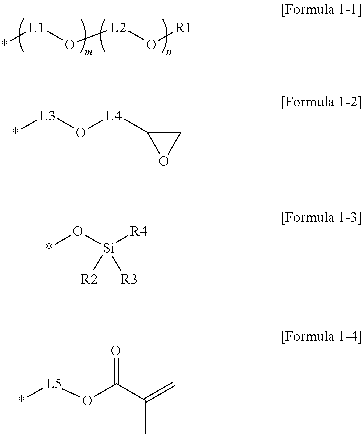

wherein,

L1 to L5 are a C1 to C30 alkylene group;

R1 to R4 are selected from the group consisting of hydrogen; a hydroxyl group; an amino group; a thiol group; a C1 to C30 alkyl group; a C2 to C30 alkenyl group; a C2 to C30 alkynyl group; a C1 to C30 alkoxy group; and a C1 to C30 carboxyl group,

m and n are the same as or different from each other, and are each independently an integer of 0 to 10, and

* is a binding position.

In Formula 1, R may have one or more functional groups capable of bonding with lithium ions.

In one embodiment of the present disclosure, R may be a group represented by Formula 1-1. In Formula 1-1, L1 and L2 may be a C1 to C30 alkylene group, preferably a C1 to C20 alkylene group, and more preferably a C1 to C10 alkylene group. In Formula 1-1, R1 may be hydrogen, a C1 to C30 alkyl group, a C2 to C30 alkenyl group, a C2 to C30 alkynyl group, a C1 to C30 alkoxy group, or a C1 to C30 carboxyl group, preferably a C1 to C20 alkyl group, a C2 to C20 alkenyl group, a C2 to C20 alkynyl group, a C1 to C20 alkoxy group or a C1 to C20 carboxyl group, and more preferably a C1 to C10 alkyl group, a C2 to C10 alkenyl group, a C2 to C10 alkynyl group, a C1 to C10 alkoxy group, or a C1 to C10 carboxyl group.

In another embodiment of the present disclosure, R may be a group represented by Formula 1-2. In Formula 1-2, L3 and L4 may be a C1 to C30 alkylene group, preferably a C1 to C20 alkylene group, and more preferably a C1 to C10 alkylene group.

In another embodiment of the present disclosure, R may be a group represented by Formula 1-3. In Formula 1-3, R2 to R4 are the same as or different from each other, and each independently may be hydrogen, a hydroxyl group, a C1 to C30 alkyl group, a C2 to C30 alkenyl group, a C2 to C30 alkynyl group, or a C1 to C30 alkoxy group, preferably hydrogen, a hydroxyl group, a C1 to C20 alkyl group, a C2 to C20 alkenyl group, a C2 to C20 alkynyl group or a C1 to C20 alkoxy group, and more preferably, hydrogen, a hydroxyl group, a C1 to C10 alkyl group, a C2 to C10 alkenyl group, a C2 to C10 alkynyl group, or a C1 to C10 alkoxy group.

In another embodiment of the present disclosure, R may be a group represented by Formula 1-4. In Formula 1-4, L5 may be a C1 to C30 alkylene group, preferably a C1 to C20 alkylene group, and more preferably a C1 to C10 alkylene group.

For example, in Formula 1, R may be selected from the group consisting of a polyethylene glycol group, a glycidyl group, a dimethylsilyloxy group, and a methacryl group, R may be

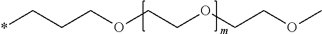

(wherein, m is an integer from 1 to 9),

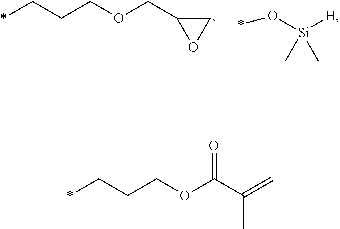

(wherein * is a binding position), but is not limited thereto.

In one embodiment of the present disclosure, the polymer may be a polymer in which phase separation does not occur when mixed with the liquid phase polyhedral oligomeric silsesquioxane. The polymer may be a solid phase polymer that is compatible with the liquid phase polyhedral oligomeric silsesquioxane by mixing it in an appropriate ratio, that is, the polymer has compatibility with the liquid phase POSS.

Specifically, the polymer may comprise a polypropylene carbonate (PPC), a polyvinylidene fluoride (PVDF), a polyacrylonitrile (PAN), or a polyvinylpyrrolidone (PVP), as a main chain or a side chain.

In one embodiment of the present disclosure, the solid phase-liquid phase hybrid electrolyte membrane comprising the polymer and the liquid phase polyhedral oligomeric silsesquioxane represented by Formula 1 may further comprise a lithium salt.

The lithium salt may act as a source of lithium ions in the battery to enable basic operation of the lithium secondary battery and may serve to promote movement of lithium ions between the positive electrode and the negative electrode. The lithium salt may be one selected from the group consisting of LiPF₆, LiBF₄, LiSbF₆, LiAsF₆, LiOH, LiOH·H₂O, LiBOB, LiClO₄, LiN(C₂F₅SO₂)₂, LiN(CF₃SO₂)₂, CF₃SO₃Li, LiC(CF₃SO₂)₃, LiC₄BO₈, LiFSI, LiClO₄ and combinations thereof, but is not limited thereto.

The content of the lithium salt may be 10 to 50 parts by weight, preferably 15 to 45 parts by weight, and more preferably 20 to 40 parts by weight based on a total of 100 parts by weight of the electrolyte membrane. If the content of the lithium salt is less than 10 parts by weight, since the content is low, the ionic conductivity of the electrolyte membrane may be lowered. If the content is more than 50 parts by weight, since all lithium salts are not dissociated in the electrolyte membrane and exist in a crystalline state, they do not contribute to the ion conductivity, but rather act as a hindrance to the ion conductivity, and thus the ion conductivity can be reduced, and since the content of the polymer is relatively reduced, the mechanical strength of the solid phase-liquid phase hybrid electrolyte membrane may be weakened. Therefore, the content of the lithium salt is appropriately adjusted within the above range.

In one embodiment of the present disclosure, the content ratio of the polymer, and sum of the liquid phase polyhedral oligomeric silsesquioxane and the lithium salt may be from 1:1 to 1:8, preferably from 1:1 to 1:6, and more preferably from 1:1 to 1:4. If the content ratio of the polymer, and sum of the liquid phase polyhedral oligomeric silsesquioxane and the lithium salt exceeds 1:1 to 1:8, there is a problem in that leakage occurs because they do not exist in the solid phase.

In one embodiment of the present disclosure, the content ratio of the liquid phase polyhedral oligomeric silsesquioxane and the lithium salt may be from 10:1 to 1:5, preferably from 10:1 to 1:1, and more preferably from 10:1 to 2:1. If the content ratio of the liquid phase polyhedral oligomeric silsesquioxane and the lithium salt is less than 10:1 to 1:5, since the amount of lithium ions is small, the ion conductivity is reduced. If the content ratio exceeds 10:1 to 1:5, since the lithium ions are excessive, they are not dissociated but are precipitated, or since the viscosity is increased, the ion conductivity is reduced.

In one embodiment of the present disclosure, the ion conductivity of the solid phase-liquid phase hybrid electrolyte membrane may be from 1.0×10⁻⁷ to 9.0×10⁻⁵ S/cm, preferably from 1.1×10⁻⁷ to 8.9×10⁻⁷ S/cm.

In one embodiment of the present disclosure, the electrical resistivity of the solid phase-liquid phase hybrid electrolyte membrane may be from 10.0 to 60, 000 ohm (Ω), preferably from 50.0 to 55,000 ohm (Ω).

In the solid phase-liquid phase hybrid electrolyte membrane, as the content of liquid phase polyhedral oligomeric silsesquioxane relative to the polymer is increased, the electrical resistivity of the electrolyte membrane can be increased and the ion conductivity of the electrolyte membrane can be increased.

In one embodiment of the present disclosure, the solid phase-liquid phase hybrid electrolyte membrane may have a thickness of from 1 to 200 μm, and preferably from 5 to 195 m. If the thickness of the solid phase-liquid phase hybrid electrolyte membrane is less than 1 μm, the mechanical strength of the electrolyte membrane is weak, and thus there may be difficulties in assembling the battery or an electrical short circuit may occur. In addition, if the thickness of the solid phase-liquid phase hybrid electrolyte membrane exceeds 200 μm, the energy density and the ion conductivity are lowered, thereby making it difficult to apply to a battery.

In one embodiment of the present disclosure, the present disclosure provides a lithium secondary battery comprising a positive electrode, a negative electrode, and a separator interposed between the positive electrode and the negative electrode, wherein the separator may include a solid phase-liquid phase hybrid electrolyte membrane according to the present disclosure.

The positive electrode and the negative electrode have a current collector and an electrode active material layer formed on at least one surface of the current collector, and the active material layer includes a plurality of electrode active material particles and a solid electrolyte. In addition, the electrode may further comprise at least one of an electrically conductive material and a binder resin, if necessary. In addition, the electrode may further include various additives for the purpose of supplementing or improving the physicochemical properties of the electrode.

In the present disclosure, any negative electrode active material may be used as long as it is usable as a negative electrode active material for a lithium-ion secondary battery. For example, the negative electrode active material may be one or two or more species selected from carbon such as non-graphitizable carbon and graphite-based carbon; metal composite oxides such as LiₓFe₂O₃ (0≤x≤1), LiₓWO₂ (0≤x≤1), SnₓMe₁₋ₓMe′_{y}O_{z} (Me is Mn, Fe, Pb and Ge; Me′ is Al, B, P, Si, elements of groups 1, 2, and 3 of the periodic table, halogen; 0<x≤1; 1≤y≤3; 1≤z≤8); lithium metal; lithium alloy; silicon-based alloy; tin-based alloy; metal oxide such as SnO, SnO₂, PbO, PbO₂, Pb₂O₃, Pb₃O₄, Sb₂O₃, Sb204, Sb205, Geo, GeO₂, Bi₂O₃, Bi204, and Bi205; an electrical conductivity polymer such as polyacetylene; Li—Co—Ni based material; titanium oxide; lithium titanium oxide. In one specific embodiment, the negative electrode active material may comprise a carbonaceous material and/or Si.

In the case of the positive electrode, the electrode active material is not particularly limited as long as it can be used as a positive electrode active material for a lithium-ion secondary battery. For example, the positive electrode active material may be layered compounds such as lithium cobalt oxide (LiCoO₂) and lithium nickel oxide (LiNiO₂) or compounds substituted with one or more transition metals; lithium manganese oxides such as formula Li₁₊ₓMn₂₋ₓO₄ (wherein, x is 0˜0.33), LiMnO₃, LiMn₂O₃, and LiMnO₂; lithium copper oxide (Li₂CuO₂); vanadium oxides such as LiV₃O₈, LiFe₃O₄, V₂O₅, and Cu₂V₂O₇; Ni site type lithium nickel oxide represented by LiNi₁₋ₓMₓO₂ (wherein, M=Co, Mn, Al, Cu, Fe, Mg, B or Ga, and x=0.01˜0.3); lithium manganese composite oxide represented by formula LiMn₂₋ₓMₓO₂ (wherein, M=Co, Ni, Fe, Cr, Zn or Ta, and x=0.01˜0.1) or Li₂Mn₃MO₈ (wherein, M=Fe, Co, Ni, Cu or Zn); lithium manganese composite oxide with spinel structure represented by formula LiNiₓMn₂₋ₓO₄; LiMn₂O₄ in which part of Li in the formula is substituted with alkaline earth metal ions; a disulfide compound; Fe₂(MoO₄)₃. However, the positive electrode active material is not limited only to these.

In the present disclosure, the current collector is one that exhibits electrical conductivity, such as a metal plate, and an appropriate one may be used depending on the polarity of a current collector electrode known in the field of a secondary battery.

In the present disclosure, the electrically conductive material is for imparting conductivity to the electrode, and is typically added in an amount of 1 to 30% by weight based on the total weight of the mixture comprising the electrode active material. The conductive electrically material is not particularly limited as long as it has conductivity without causing chemical change in the battery, and for example, may comprise one selected from graphite such as natural graphite or artificial graphite; carbonaceous materials such as carbon black, acetylene black, Ketjen black, channel black, furnace black, lamp black, and thermal black; electrically conductive fibers such as carbon fibers and metal fibers; carbon fluoride; metal powders such as aluminum powder and nickel powder; electrically conductive whiskers such as zinc oxide and potassium titanate; electrically conductive metal oxides such as titanium oxide; electrically conductive materials such as polyphenylene derivatives, or a mixture of two or more thereof.

In the present disclosure, the binder resin serves to well attach the negative electrode active material particles to each other and to well attach the negative electrode active material to the current collector, and is not particularly limited as long as it is a component that assists in the binding of the active material and the electrically conductive material and the binding to the current collector, and for example may be polyvinylidene fluoride polyvinyl alcohol, carboxymethylcellulose (CMC), starch, hydroxypropyl cellulose, regenerated cellulose, polyvinylpyrrolidone, tetrafluoroethylene, polyethylene, polypropylene, ethylene-propylene-diene monomer (EPDM), sulfonated EPDM, styrene-butylene rubber, fluorine rubber, or various copolymers etc. The binder resin may be typically included in an amount ranging from 1 to 30% by weight, or 1 to 10% by weight based on 100% by weight of the electrode layer.

Meanwhile, in the present disclosure, the electrode active material layer may comprise one or more additives such as an oxidation stabilization additive, a reduction stabilization additive, a flame retardant, a heat stabilizer, and an antifogging agent, if necessary.

Hereinafter, the present disclosure will be described in more detail through examples, but the following examples are intended to illustrate the present disclosure, and the scope of the present disclosure is not limited to these only.

### EXAMPLES

### Example 1

10 wt. % of polyvinylidene fluoride (PVDF) (Sigma-Aldrich) as a polymer was added to N-methyl-2-pyrrolidone (NMP), and sufficiently stirred at 60° C. to prepare solution A.

Polyethylene glycol-polyhedral oligomeric silsesquioxane lithium (PEG-POSS) (Hybridplastics) and bis(trifluoromethanesulfonyl)imide (LiTFSI) (Sigma-Aldrich) were sufficiently stirred at 60° C. in a weight ratio of 10:4 to prepare solution B.

The solutions A and B were sufficiently stirred at room temperature for 24 hours so that the content ratio of PVDF:PEG-POSS-LiTFSI was 1:2.

The prepared solution was coated on Stainless Steel Foil (SUS foil) with a doctor blade, and then vacuum dried at 100° C. for 12 hours to prepare a solid electrolyte membrane.

### Example 2

A solid electrolyte membrane was manufactured in the same manner as in Example 1 above, except that the content ratio of PVDF: PEG-POSS-LiTFSI is 1:3.

### Example 3

A solid electrolyte membrane was manufactured in the same manner as in Example 1 above, except that the content ratio of PVDF: PEG-POSS-LiTFSI is 1:4.

### Example 4

A solid electrolyte membrane was manufactured in the same manner as in Example 1 above, except that in Example 1 above, polypropylene carbonate (PPC) is used instead of PVDF.

### Example 5

A solid electrolyte membrane was manufactured in the same manner as in Example 1 above, except that in Example 1 above, polyacrylonitrile (PAN) is used instead of PVDF and the content ratio of PAN: PEG-POSS-LiTFSI is 1:1.

### Example 6

A solid electrolyte membrane was manufactured in the same manner as in Example 1 above, except that in Example 1 above, polyacrylonitrile (PAN) is used instead of PVDF and the content ratio of PAN: PEG-POSS-LiTFSI is 1:2.

### Example 7

A solid electrolyte membrane was manufactured in the same manner as in Example 1 above, except that in Example 1 above, polyvinylpyrrolidone (PVP) is used instead of PVDF and the content ratio of PVP: PEG-POSS-LiTFSI is 1:1.

### Example 8

A solid electrolyte membrane was manufactured in the same manner as in Example 1 above, except that in Example 1 above, polyvinylpyrrolidone (PVP) is used instead of PVDF.

### Example 9

A solid electrolyte membrane was manufactured in the same manner as in Example 2 above, except that in Example 2 above, Glycidyl-POSS-LiTFSI is used instead of PEG-POSS-LiTFSI.

### Example 10

A solid electrolyte membrane was manufactured in the same manner as in Example 2 above, except that in Example 2 above, Octadimethylsilyloxy-POSS-LiTFSI is used instead of PEG-POSS-LiTFSI.

### Comparative Example 1

10 wt. % of polyvinylidene fluoride (PVDF) (Sigma-Aldrich) as a polymer was added to N-methyl-2-pyrrolidone (NMP), and sufficiently stirred at 60° C. to prepare a solution.

The solution was sufficiently stirred at room temperature for 24 hours so that the content ratio of PVDF:LiTFSI was 10:2.

The prepared solution was coated on Stainless Steel Foil (SUS foil) with a doctor blade, and then vacuum dried at 100° C. for 12 hours to prepare a solid electrolyte membrane.

### Comparative Example 2

A solid electrolyte membrane was manufactured in the same manner as in Comparative Example 1 above, except that in Comparative Example 1 above, polypropylene carbonate (PPC) is used instead of PVDF, and the content ratio of PPC: LiTFSI is 10:3.

### Comparative Example 3

A solid electrolyte membrane was manufactured in the same manner as in Comparative Example 1 above, except that in Comparative Example 1 above, PAN is used instead of PVDF, and the content ratio of PAN: LiTFSI is 10:5.

### Comparative Example 4

A solid electrolyte membrane was manufactured in the same manner as in Comparative Example 1 above, except that in Comparative Example 1 above, polyvinylpyrrolidone (PVP) is used instead of PVDF.

### Comparative Example 5

A solid electrolyte membrane was manufactured in the same manner as in Comparative Example 1 above, except that in Comparative Example 1 above, PEG-POSS-LiTFSI is used instead of LiTFSI, and the content ratio of PVDF: PEG-POSS-LiTFSI is 1:6.

### Experimental Example 1: Ion Conductivity of Solid Phase-Liquid Phase Hybrid Electrolyte Membrane at Atmospheric Pressure

Using VMP3 (Bio logic science instrument) which is an analysis device, the electrochemical impedance was measured under conditions of an amplitude of 10 mV and a scan range of 500 KHz to 20 MHz at 23° C., and based on this, the ion conductivity was calculated using Equation 1 below.

$$σ = \frac{l}{Ra} \qquad [ Equation 1 ]$$

wherein, σ is the ion conductivity, 1 is the film thickness, R is the resistance, and a is the area.

The ion conductivity obtained using Equation 1 is shown in Table 1 below.

TABLE 1

| | | Thick- | | Ion |
|---|---|---|---|---|
| | | ness | Resistance | conductivity |
| | Sample | (μm) | (ohm) | (S/cm) |
| Example 1 | PVDF:PEG-POSS- | 5 | 264.0 | 9.42.E−07 |
| | LiTFSI = 1:2 | | | |
| Example 2 | PVDF:PEG-POSS- | 33 | 165.0 | 9.95.E−06 |
| | LiTFSI = 1:3 | | | |
| Example 3 | PVDF:PEG-POSS- | 96 | 54.0 | 8.85.E−05 |
| | LiTFSI = 1:4 | | | |
| Example 4 | PPC:PEG-POSS- | 70 | 350.0 | 9.95.E−06 |
| | LiTFSI = 1:2 | | | |
| Example 5 | PAN:PEG-POSS- | 147 | 38,000.0 | 1.92.E−07 |
| | LiTFSI = 1:1 | | | |
| Example 6 | PAN:PEG-POSS- | 170 | 13,000.0 | 6.51.E−07 |
| | LiTFSI = 1:2 | | | |
| Example 7 | PVP:PEG-POSS- | 120 | 50,000.0 | 1.14.E−07 |
| | LiTFSI = 1:1 | | | |
| Example 8 | PVP:PEG-POSS- | 70 | 9,000.0 | 3.88.E−07 |
| | LiTFSI = 1:2 | | | |
| Example 9 | PVDF:Glycidyl-POSS- | 25 | 755.0 | 1.65.E−06 |
| | LiTFSI = 1:3 | | | |
| Example 10 | PVDF:Octadimethyl- | 28 | 723.0 | 1.93.E−06 |
| | silyloxy-POSS- | | | |
| | LiTFSI = 1:3 | | | |
| Comparative | PVDF:LiTFSI = | 18 | — | — |
| Example 1 | 10:2 | | | |
| Comparative | PPC:LiTFSI = | 30 | 130,000.0 | 1.15.E−08 |
| Example 2 | 10:3 | | | |
| Comparative | PAN:LiTFSI = | 72 | 100,000.0 | 3.58.E−08 |
| Example 3 | 10:5 | | | |
| Comparative | PVP:LiTFSI = | 18 | — | — |
| Example 4 | 10:2 | | | |
| Comparative | PVDF:PEG-POSS- | — | — | — |
| Example 5 | LiTFSI = 1:6 | | | |

In Table 1, according to the present disclosure, it was confirmed that the ion conductivity of an electrolyte membrane containing a polymer and POSS and containing a specific content ratio of the polymer and POSS is improved. On the other hand, it was found that in the case of an electrolyte membrane that does not contain the polymer with low ion conductivity and POSS, the ion conductivity was low.

### Experimental Example 2: Weight Change at High Pressure of Solid Phase-Liquid Phase Hybrid Electrolyte Membrane

In order to evaluate the leakage characteristics of the electrolyte membrane, the prepared electrolyte membrane was punched out with a diameter of 1.9 cm, and the separator was interposed on one side thereof, and then put between jigs and pressed at a pressure of 1 MPa for 1 minute, and the weight before and after pressurization was measured and the weight change was calculated using Equation 2 below.

$$Amount of weight change ( \% ) = \{ ( weight before pressurization - weight after pressurization ) \text{} / weight before pressurization \} * 100 \qquad [ Equation 2 ]$$

The amount of weight change is shown in Table 2 below.

TABLE 2

| | Amount of weight change (%) |
|---|---|
| Example 1 | not measured |
| Example 2 | 0.1 |
| Example 3 | 0.2 |
| Example 4 | 0 |
| Example 5 | not measured |
| Example 6 | 0.1 |
| Example 7 | not measured |
| Example 8 | 0 |
| Example 9 | 0.1 |
| Example 10 | 0.1 |
| Comparative Example 1 | 0.1 |
| Comparative Example 2 | not measured |
| Comparative Example 3 | not measured |
| Comparative Example 4 | not measured |
| Comparative Example 5 | 5.2 |

In Table 2 above, it was confirmed that the solid phase-liquid phase hybrid electrolyte membrane according to the present disclosure has a weight change of 0.2% or less, and the leakage of the electrolyte membrane hardly occurs. On the other hand, it was confirmed that in Comparative Example 5, when an excessive amount of POSS was included, the weight change of the electrolyte membrane was greatly changed to 5.2%, and it did not have the form of a solid phase electrolyte membrane, and the leakage of the electrolyte membrane occurred when pressure was applied.

### DESCRIPTION OF REFERENCE NUMERALS

10: Solid phase-liquid phase hybrid electrolyte membrane
1: Solid phase polymer
2: Liquid phase polyhedral oligomeric silsesquioxane

1. A solid phase-liquid phase hybrid electrolyte membrane, comprising:
a polymer;
a liquid phase polyhedral oligomeric silsesquioxane (POSS) represented by the following Formula 1; and
a lithium salt, 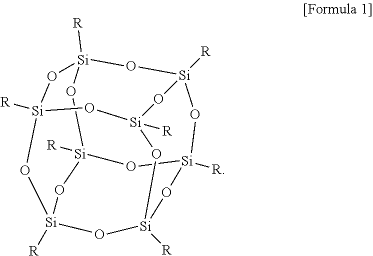
wherein,
each R is the same as or different from each other, and is independently selected from the group consisting of groups represented by Formulas 1-1 to 1-4, 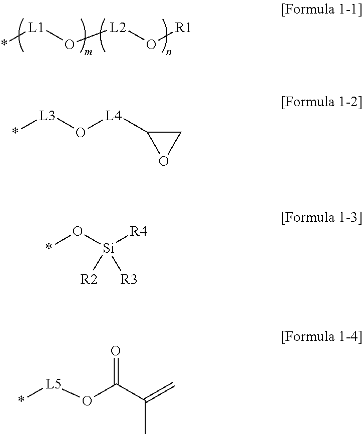
wherein,
L1 to L5 are a C1 to C30 alkylene group,
R1 to R4 are selected from the group consisting of hydrogen; a hydroxyl group; an amino group; a thiol group; a C1 to C30 alkyl group; a C2 to C30 alkenyl group; a C2 to C30 alkynyl group; a C1 to C30 alkoxy group; and a C1 to C30 carboxyl group,
m and n are the same as or different from each other, and are each independently an integer of 0 to 10, and
* is a binding position.

2. The solid phase-liquid phase hybrid electrolyte membrane according to claim 1, wherein in Formula 1-1 to 1-4,
L1 to L5 are a C1 to C10 alkylene group,
R1 to R4 are hydrogen; hydroxyl group; or a C1 to C30 alkyl group.

3. The solid phase-liquid phase hybrid electrolyte membrane according to claim 1, wherein R is selected from the group consisting of a polyethylene glycol group, a glycidyl group, a dimethylsilyloxy group and a methacrylic group.

4. The solid phase-liquid phase hybrid electrolyte membrane according to claim 1, wherein the polymer comprises a polypropylene carbonate (PPC), a polyvinylidene fluoride (PVDF), a polyacrylonitrile (PAN), or polyvinylpyrrolidone (PVP), as a main chain or a side chain.

5. The solid phase-liquid phase hybrid electrolyte membrane according to claim 1, wherein the lithium salt comprises one selected from the group consisting of LiPF₆, LiBF₄, LiSbF₆, LiAsF₆, LiOH, LiOH·H₂O, LiBOB, LiClO₄, LiN(C₂F₅SO₂)₂, LiN(CF₃SO₂)₂, CF₃SO₃Li, LiC(CF₃SO₂)₃, LiC₄BO₈, LiFSI, LiClO₄ and a combination thereof.

6. The solid phase-liquid phase hybrid electrolyte membrane according to claim 1, wherein a content ratio of the polymer and sum of the liquid phase polyhedral oligomeric silsesquioxane and the lithium salt is 1:-1 to 1:-8.

7. The solid phase-liquid phase hybrid electrolyte membrane according to claim 1, wherein a content ratio of the liquid phase polyhedral oligomeric silsesquioxane and the lithium salt is from 10:−1 to 1:−5.

8. The solid phase-liquid phase hybrid electrolyte membrane according to claim 1, wherein an ion conductivity of the solid phase-liquid phase hybrid electrolyte membrane is from 1.0×10⁻⁷ to 9.0×10⁵ S/cm at 25° C.

9. The solid phase-liquid phase hybrid electrolyte membrane according to claim 1, wherein a thickness of the solid phase-liquid phase hybrid electrolyte membrane is from 1 to 200 μm.

10. A lithium secondary battery comprising:
a positive electrode;
a negative electrode; and
the solid phase-liquid phase hybrid electrolyte membrane according to claim 1.
